(19) United States
(12) Patent Application Publication
(10) Pub. No.: US 2025/0330369 A1
(43) Pub. Date: Oct. 23, 2025

(54) Fast Detection of OAM Processor (OAMP) Failure Using Hardware Acceleration

(71) Applicant: Arista Networks, Inc., Santa Clara, CA (US)

(72) Inventors: Navlok MISHRA, Bengaluru (IN); Rahul Omprakash VERMA, Bengaluru (IN); Sidharth ROZARIO, Bengaluru (IN); Milind Vasant KULKARNI, Bengaluru (IN); Suneel VENATI, Bengaluru (IN)

(21) Appl. No.: 18/641,852

(22) Filed: Apr. 22, 2024

(51) Int. Cl. H04L 41/0604; H04L 41/0663

(52) U.S. Cl. CPC H04L 41/0627; H04L 41/0663

(57) ABSTRACT

A framework for quickly detecting the failure of an OAM processor (OAMP) in a network device that includes multiple OAMPs is provided. In certain embodiments, this framework achieves fast OAMP failure detection by leveraging the OAMPs' ability to accelerate one or more OAM fault detection protocols. One such protocol is the Continuity Check (CC) protocol provided by the IEEE 802.1ag standard.

### BACKGROUND

An Operations, Administration, and Management (OAM) processor is a hardware component of a network device that accelerates various OAM protocols and functions, including those defined under the Institute of Electrical and Electronics Engineers (IEEE) 802.1ag standard. This standard, also known as Connectivity Fault Management (CFM), pertains to the detection and isolation of connectivity faults in Ethernet networks.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device.

FIG. 2 depicts an enhanced version of the network device of FIG. 1 in accordance with certain embodiments of the present disclosure.

FIG. 3 depicts an OAMP configuration workflow in accordance with certain embodiments of the present disclosure.

FIGS. 4 and 5 depict Continuity Check (CC) protocol execution workflows in accordance with certain embodiments of the present disclosure.

FIGS. 6 and 7 depict an example scenario in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

The present disclosure is directed to a framework for quickly detecting the failure of an OAM processor (OAMP) in a network device that includes multiple OAMPs. In certain embodiments, this framework achieves fast OAMP failure detection by leveraging the OAMPs' ability to accelerate one or more OAM fault detection protocols. One such protocol is the Continuity Check (CC) protocol provided by CFM.

### 1. Example Network Device

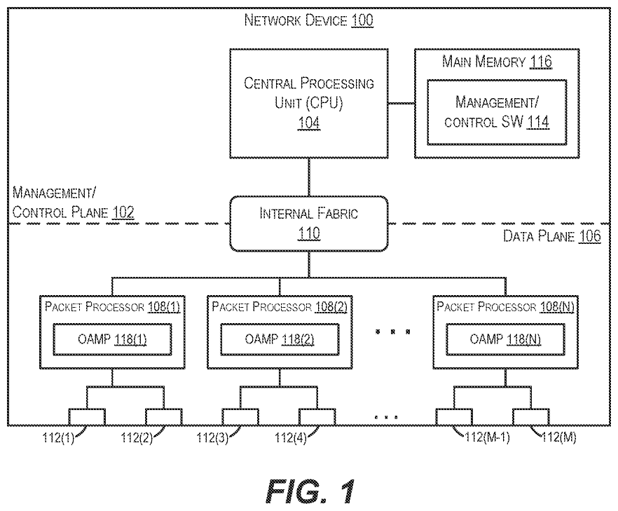

FIG. 1 is a simplified block diagram of an example network device 100 in which the framework of the present disclosure can be implemented. Network device 100 may be a network switch, a network router, or any other type of device or system operable for transmitting and/or processing network packets in a computer network.

As shown, network device 100 includes a management/control plane 102 comprising a central processing unit (CPU) 104 and a data plane 106 comprising a plurality of packet processors 108(1)-(N). Packet processors 108(1)-(N) are communicatively coupled with CPU 104 and with each other via an internal fabric 110. In addition, each packet processor 108 is connected to, and thus handles the traffic for, a subset of the front panel interfaces of network device 100 (i.e., interfaces 112(1)-(M)). For example, in FIG. 1 packet processor 108(1) is connected to interfaces 112(1) and 112(2), packet processor 108(2) is connected to interfaces 112(3) and 112(4), and packet processor 108(N) is connected to interfaces 112(M−1) and 112(M). This particular mapping between interfaces 112(1)-(M) and packet processors 108(1)-(N) is shown for illustration purposes only; in practice, each packet processor 108 may be connected to any subset of the front panel interfaces of network device 100.

CPU 104 is a general-purpose processor that is responsible for managing the configuration of network device 100 and controlling the device's understanding of the network in which it resides. CPU 104 carries out these functions under the direction of management/control software 114 (e.g., an operating system (OS)) that runs on the CPU from a main memory 116 (e.g., a random-access memory (RAM)).

Packet processors 108(1)-(N) are integrated circuits, such as, but not limited to, application-specific integrated circuits (ASICs) or field-programmable gate arrays (FPGAs), that are responsible for performing line-speed processing of network packets that pass through network device 100 via interfaces 112(1)-(M). For example, packet processors 108(1)-(N) may perform Layer 2 (L2) forwarding and/or Layer 3 (L3) routing of inbound network traffic.

Packet processors 108(1)-(N) are also responsible for implementing OAM capabilities in network device 100 (e.g., fault detection and isolation, performance monitoring, etc.) using respective OAMPs 118(1)-(N). As mentioned previously, an OAMP is a hardware component that accelerates certain OAM protocols and functions, which means the protocols/functions are executed on OAMP hardware (with minimal or no intervention by the device CPU). Some of the OAM functions and protocols accelerated by OAMPs 118(1)-(N) are defined in industry standards such as IEEE 802.1ag (CFM), International Telecommunication Union-Telecommunication Standardization Sector (ITU-T) Y.1731, and Internet Engineering Task Force (IETF) RFC 5880 (which pertains to Bidirectional Forwarding Detection (BFD)).

By way of example, one OAM protocol that is provided by CFM and accelerated by OAMPs 118(1)-(N) is Continuity Check (CC) protocol. This protocol employs heartbeat messages, referred to as Continuity Check Messages (CCMs), to detect connectivity failures between two network endpoints, referred to as Maintenance End Points (MEPs). The CC protocol generally proceeds as follows between two MEPs M1 and M2. These MEPs will typically correspond to logical or physical interfaces on two different network devices in a network (e.g., devices at the boundaries of a “maintenance domain” as defined under the CFM standard).
1. M1 generates and sends CCMs on a periodic basis; similarly, M2 generates and sends CCMs on a periodic basis.
2. Both M1 and M2 monitor for receipt of CCMs from the other (i.e., remote) MEPs.
3. Upon determining that it has not received a CCM from the remote MEP within a predefined time window, M1/2 concludes that connectivity has been lost to the remote MEP and raises a loss of continuity (LOC) signal indicating this connectivity failure.

When a MEP is configured on an interface of network device 100, the functionalities of generating and sending out CCMs (referred to as MEP transmitter functionality) and monitoring for receipt of CCMs (referred to as MEP monitor functionality) will be executed in hardware by one or more of the device's OAMPs 118(1)-(N). For example, assume MEP M1 is configured on interface 112(1). In this case, OAMP 118(1) of packet processor 108(1) (i.e., the packet processor connected to interface 112(1)) will generate/send CCMs and monitor for CCMs from M2.

### 2. Solution Overview

In a network device like device 100 of FIG. 1 that comprises multiple OAMPs, there are several scenarios where it is important for the network device to detect, as quickly as possible, when one of the OAMPs has failed. For instance, consider a scenario in which network device 100 employs a link aggregation group (LAG) (i.e., a logical interface/link composed of multiple physical interfaces), where each member (physical) interface in the LAG is connected to a different packet processor 108/OAMP 118 and where MEP M1 in the example above is configured on the LAG. In this scenario, only one of the OAMPs 118(1)-(N) will be selected to act as MEP transmitter in order to avoid redundant outgoing CCMs. This means that if the selected OAMP fails for any reason, network device 100 must quickly detect the failure and fail over the MEP transmitter functionality to another still, active OAMP. If the detection and failover take too long, remote MEP M2 may erroneously conclude that connectivity to MEP M1 has gone down (when in fact only the MEP transmitter OAMP of the LAG corresponding to M1 has failed).

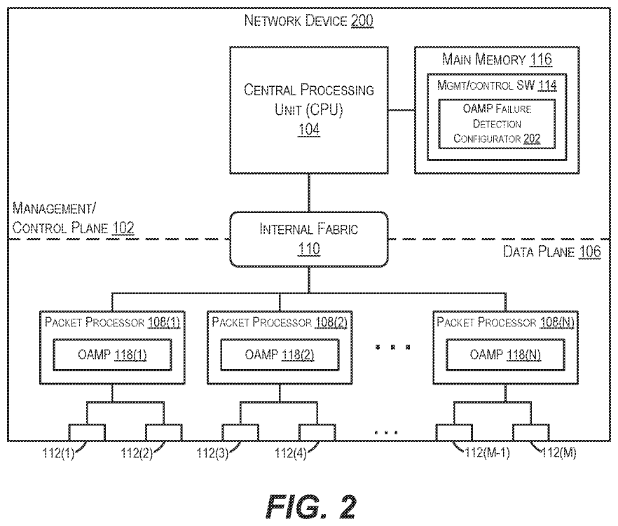

To address the foregoing and other similar scenarios, FIG. 2 depicts an enhanced version 200 of network device 100 that implements a novel OAMP failure detection framework comprising an OAMP failure detection configurator 202 (hereinafter simply “configurator”) in management/control software 114. At a high level, configurator 202 can configure OAMPs 118(1)-(N) as MEPs under the CC protocol (or under another similar OAM fault detection protocol), thereby enabling the OAMPs to leverage their hardware acceleration of this protocol to quickly detect OAMP failures.

For example, as part of the configuration process, configurator 202 can assign a unique MEP identifier (ID) to each OAMP 118 and provide the MEP IDs of the other OAMPs to each OAMP as remote MEP IDs. The MEP ID assigned to each MEP will be unique in the context of a given management domain (MD) and management association (MA) under which the MEP is configured, as defined in the CFM standard. Configurator 202 can also program a CCM transmission interval into OAMPs 118(1)-(N) that indicates the time interval at which the OAMPs should generate and send CCMs, as well as a CCM timeout interval that indicates the amount of time each OAMP should wait for receipt of CCMs from remote MEPs.

Upon being configured in this manner, each OAMP 118 will periodically generate and send a CCM to every other OAMP in accordance with the programmed CCM transmission interval. In addition, each OAMP 118 will keep track of its connectivity to the other OAMPs by monitoring for the receipt of CCMs from those other OAMPs in accordance with the programmed CCM timeout interval. When a particular OAMP fails, all active OAMPs will stop receiving CCMs from the failed OAMP. As a result, the active OAMPs will detect this failure after the CCM timeout interval has elapsed and raise a LOC signal, thereby allowing the failure to be handled. For example, in the LAG scenario above where the failed OAMP was selected as MEP transmitter for generating and sending CCMs to remote MEPs, this MEP transmitter functionality can be failed over to another, active OAMP.

By treating OAMPs 118(1)-(N) as MEPs and leveraging their built-in acceleration of the CC protocol, the framework of the present disclosure advantageously enables the OAMPs to detect a failure of one of their peers quickly and efficiently, without impacting the performance of network device 200. Some existing OAMPs support a minimum CCM transmission interval of 1.67 milliseconds (ms); for these OAMPs, failure detection in accordance with the framework can be achieved as quickly as 2×1.67=3.34 ms, which is sufficiently fast for most or all scenarios where quick OAMP failure detection is useful and/or needed.

It should be appreciated that FIGS. 1 and 2 and the foregoing solution overview are illustrative and not intended to limit embodiments of the present disclosure. For example, while the solution overview describes the use of CC protocol for enabling fast OAMP failure detection, the framework of the present disclosure may alternatively employ other OAM fault detection protocols and/or mechanisms that are accelerated by OAMPs 118(1)-(N) (such as, e.g., BFD) for this purpose. In these alternative embodiments, configurator 202 may configure OAMPs 118(1)-(N) as required by those other protocols/mechanisms in order to monitor their connectivity to each other in hardware.

Further, the LAG scenario described above is merely one example application/use case for the framework of the present disclosure. The framework may also be used to enable fast OAMP failure detection in other scenarios where such fast detection is desirable.

Yet further, although FIGS. 1 and 2 depict a particular arrangement of components in network device 100/200, other arrangements are possible (e.g., the functionality attributed to a particular component may be split into multiple components, components may be combined, etc.). For example, in some embodiments OAMPs 118(1)-(N) may be implemented as standalone ICs that are connected to their respective packet processors 108(1)-(N), rather than being integrated into the packet processors as shown in FIGS. 1 and 2.

### 3. OAMP Configuration Workflow

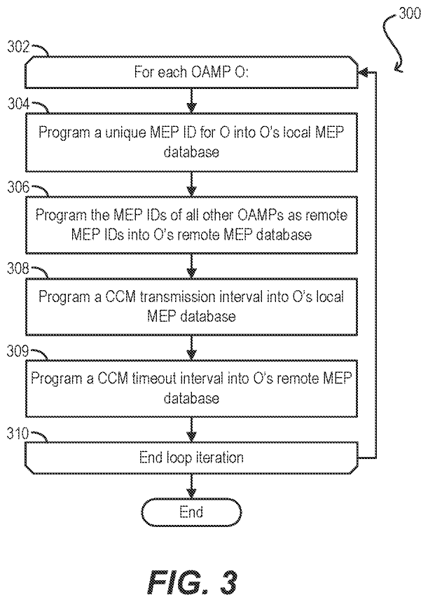

FIG. 3 depicts a workflow 300 that may be performed by configurator 202 for configuring OAMPs 118(1)-(N) of network device 200 to implement hardware-accelerated OAMP failure detection according to certain embodiments. Workflow 300 may be carried out at the time network device 200 is booted/initialized or when this OAMP failure detection feature is enabled.

Starting with step 302, configurator 202 can enter a loop for each OAMP O of network device 200. Within this loop, configurator 202 can program a unique MEP ID for OAMP O into a local MEP database of O, thereby identifying O as an MEP that will participate in the CC protocol (step 304). As mentioned previously, the programmed MEP ID will be unique in the context of a given MD and MA. In addition, configurator 202 can program the MEP IDs for all other OAMPs of network device 200 into a remote MEP database of O (step 306). This will identify those other OAMPs as remote MEPs from the perspective of OAMP O and thus cause O to (1) generate and send CCMs to the other OAMPs and (2) monitor for receipt of CCMs from the other OAMPs. In some embodiments, as part of step 306, configurator 202 can initialize a state for each remote MEP ID in the remote MEP database to a value indicating that OAMP O currently has connectivity to that remote MEP/OAMP (e.g., “reachable”).

At step 308, configurator 202 can program a CCM transmission interval into the local MEP database of OAMP O. As mentioned previously, this CCM transmission interval defines the time interval (or in other words, periodicity) at which OAMP O will generate and send out CCMs to remote MEPs. In some embodiments, configurator 202 can program the same CCM transmission interval into every OAMP 118.

At step 309, configurator 202 can program a CCM timeout interval into the remote MEP database of OAMP O. This CCM timeout interval indicates the maximum amount of time that OAMP O should wait to receive a CCM from a remote MEP before concluding that continuity has been lost to that remote MEP. In certain embodiments the CCM timeout interval can be set to a multiple of the CCM transmission interval, such as two or three times the CCM transmission interval.

Finally, at step 310 configurator 202 can reach the end of the current loop iteration and return to the top of the loop in order to configure the next OAMP. Once all OAMPs have been configured in this manner, workflow 300 can end.

### 4. CC Protocol Execution Workflows

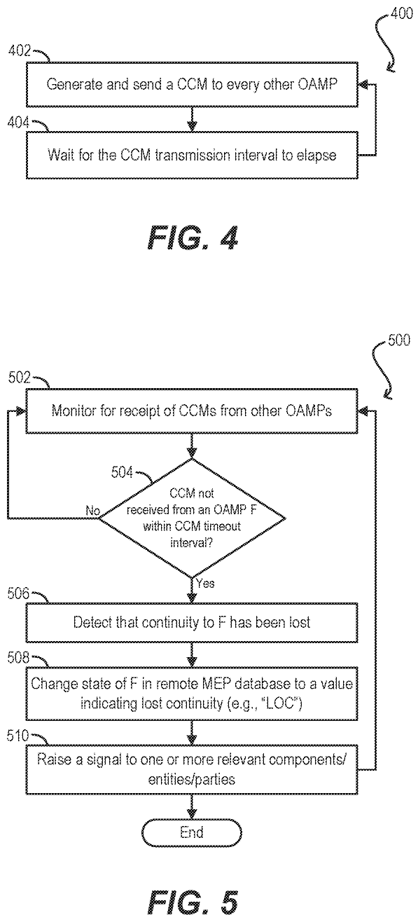

FIGS. 4 and 5 depict two workflows 400 and 500 that may be performed concurrently by each OAMP 118 of network device 200 for executing the CC protocol (and thus detecting OAMP failures) according to certain embodiments. Workflows 400 and 500 assume that OAMPs 118(1)-(N) have been configured by configurator 202, per workflow 300 of FIG. 3.

Starting step 402 of workflow 400, the OAMP can generate and send a CCM to every other OAMP in network device 200.

Upon completing step 402, the OAMP can wait for the time interval specified by the CCM transmission interval stored in its local MEP database to elapse (step 404). Once this time interval has elapsed, the OAMP can return to step 402 in order to generate and send out the next CCM.

Turning now to workflow 500, at step 502 the OAMP can monitor for the receipt of CCMs from the other OAMPs (remote MEPs). If the OAMP receives CCMs as expected (step 504), the OAMP can continue this monitoring.

However, if the OAMP fails to receive a CCM from a given OAMP F within the CCM timeout interval stored in its remote MPEP database (step 504), the OAMP can detect that continuity (or in other words, connectivity) to F has been lost (step 506) and change the state of F in its remote MEP database to a value indicating the lost continuity (e.g., “LOC”) (step 508). Finally, the OAMP can raise a signal to this effect to one or more relevant components/entities/parties (510) and return to step 502.

Although not shown in workflow 500, the notified components/entities/parties can subsequently take one or more actions in order to handle the loss of continuity to OAMP F detected at step 506 (which is considered a failure of F). In one set of embodiments the LOC signal can be raised to management/control software 114, which can failover some functionality previously assigned to OAMP F (e.g., MEP transmitter functionality) to another, active OAMP of network device 200. In another set of embodiments, the LOC signal can be raised to the OAMP itself (and/or to one or more of the other, active OAMPs), and the active OAMP(s) can directly handle the failure in some manner in hardware. For example, in a particular embodiment a priority may be assigned to each OAMP 118 and, upon failure of a given OAMP, the active OAMP with the highest assigned priority may automatically take over any functionalities assigned to the failed OAMP.

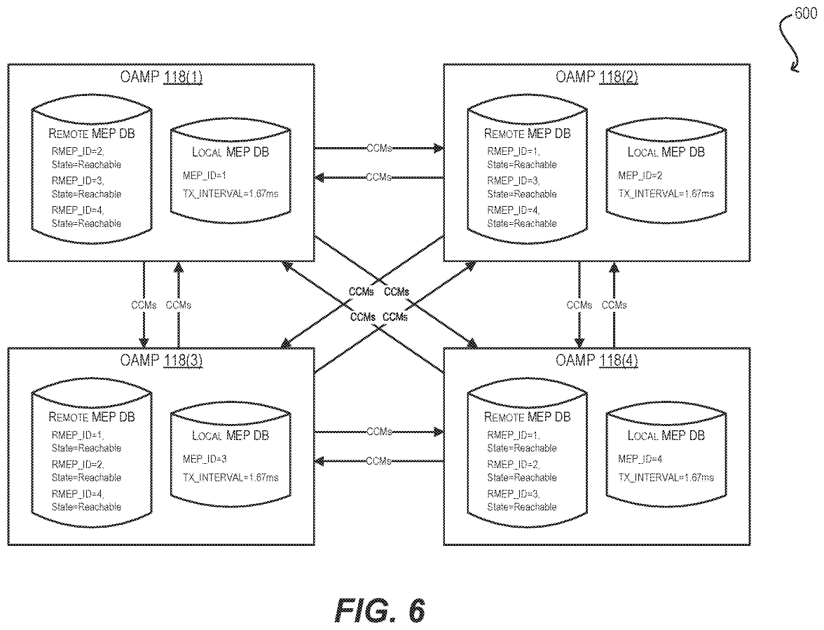

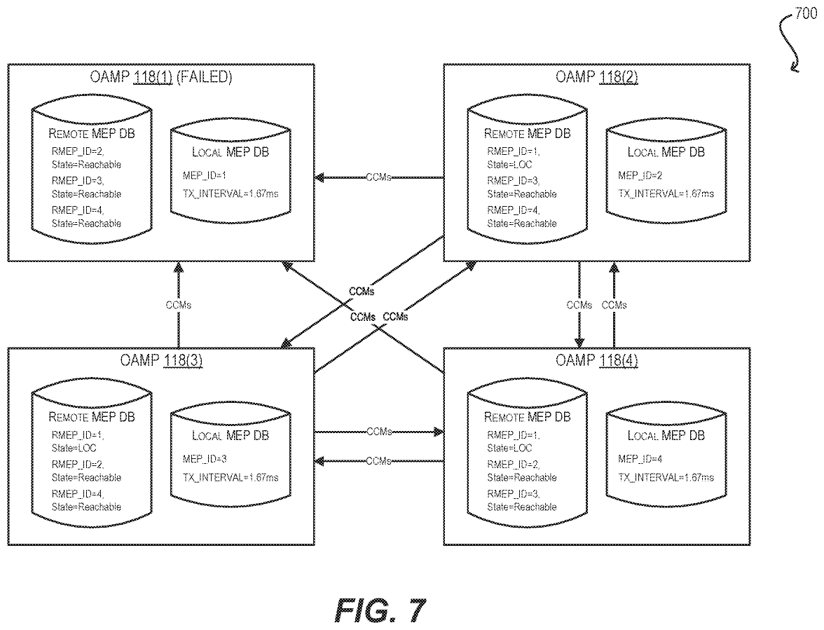

To further clarify the CC protocol processing described above, FIGS. 6 and 7 depict diagrams 600 and 700 that present an example scenario comprising four OAMPs 118(1)-(4) (having MEP IDs 1, 2, 3, and 4 respectively). This scenario assumes that the OAMPs have been configured by configurator 202 in accordance with workflow 300 of FIG. 3 and are executing the CC protocol in accordance with workflows 400 and 500 of FIGS. 4 and 5.

In diagram 600, all four OAMPs are reachable/active and are sending CCMs to each other. Thus, the state of each OAMP in the OAMPs' remote MEP databases is “reachable.” In diagram 700, OAMP 118(1) has failed and stopped sending CCMs to the other OAMPs. Thus, OAMPs 118(2), 118(3), and 118(4) have detected this failure and changed the state of OAMP 118(1) (identified by MEP ID 1) in their respective remote MEP databases to “LOC.”

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device that includes a plurality of Operations, Administration, and Management processors (OAMPs), the method comprising:
configuring the plurality of OAMPs to use Continuity Check (CC) protocol for monitoring their connectivity to each other, wherein the configuring causes each OAMP to:
transmit Continuity Check Messages (CCMs) on a periodic basis to other OAMPs in the plurality of OAMPs;
monitor for receipt of CCMs from the other OAMPs; and
upon failing to receive a CCM from a first OAMP in the plurality of OAMPs within a time window, raise a signal indicating loss of continuity to the first OAMP.

2. The method of claim 1 wherein said each OAMP is configured to perform the transmitting of the CCMs, the monitoring for receipt of the CCMs, and the raising of the signal in hardware.

3. The method of claim 1 wherein the configuring is performed by software running on a central processing unit (CPU) of the network device.

4. The method of claim 3 wherein said each OAMP is configured to perform the transmitting of the CCMs, the monitoring for receipt of the CCMs, and the raising of the signal without intervention by the CPU.

5. The method of claim 1 wherein the configuring comprises, for said each OAMP:
programming a unique Maintenance End Point (MEP) identifier into a local MEP database of the OAMP.

6. The method of claim 1 wherein the configuring comprises, for said each OAMP:
programming MEP identifiers of the other OAMPs into a remote MEP database of the OAMP.

7. The method of claim 6 wherein programming the MEP identifiers of the other OAMPs into the remote MEP database comprises:
initializing a state variable associated with each MEP identifier programmed into the remote MEP database with a value indicating that an OAMP identified by the MEP identifier is reachable.

8. The method of claim 7 wherein upon detecting a loss of continuity to the OAMP identified by the MEP identifier, the state variable is changed to another value indicating the loss of continuity.

9. The method of claim 1 wherein the configuring comprises, for said each OAMP:
programming a CCM transmission interval into a local MEP database of the OAMP, the CCM transmission interval indicating a time interval at which the OAMP should generate and send CCMs to the other OAMPs; and
programming a CCM timeout interval into a remote MEP database of the OAMP, the CCM timeout interval indicating an amount of time the OAMP should wait to receive CCMs from each OAMP in the plurality of OAMPs before concluding that continuity has been lost to said each OAMP.

10. The method of claim 1 wherein the signal causes the loss of continuity to be handled.

11. The method of claim 10 wherein the loss of continuity is handled by software running on a CPU of the network device.

12. The method of claim 10 wherein the loss of continuity is handled in hardware by one or more of the plurality of OAMPs.

13. The method of claim 10 wherein the handling of the loss of continuity comprises failing over one or more functionalities assigned to the first OAMP to another OAMP.

14. A network device comprising:
a plurality of Operations, Administration, and Management processors (OAMPs);
a central processing unit (CPU); and
a memory having stored thereon software that, when executed by the CPU, causes the CPU to configure the plurality of OAMPs to use Continuity Check (CC) protocol for monitoring their connectivity to each other, wherein the configuring causes each OAMP to:
transmit Continuity Check Messages (CCMs) on a periodic basis to other OAMPs in the plurality of OAMPs;
monitor for receipt of CCMs from the other OAMPs; and
upon failing to receive a CCM from a first OAMP in the plurality of OAMPs within a time window, raise a signal indicating loss of continuity to the first OAMP.

15. The network device of claim 14 wherein the network device further comprises a plurality of packet processors, and wherein each OAMP in the plurality of OAMPs is implemented in a corresponding packet processor in the plurality of packet processors.

16. The network device of claim 14 wherein said each OAMP is associated with a member interface of a link aggregation group (LAG), wherein a Maintenance End Point (MEP) is configured on the LAG that communicates via the CC protocol with one or more remote MEPs residing on one or more remote network devices, and wherein the first OAMP is selected as an MEP transmitter for generating and sending CCMs to the one or more remote MEPs.

17. The network device of claim 16 wherein in response to the signal, another OAMP in the plurality of OAMPs is selected as the MEP transmitter.

18. A method performed by a network device that includes a plurality of Operations, Administration, and Management processors (OAMPs), the method comprising:
configuring the plurality of OAMPs to use an OAM fault detection protocol for monitoring their connectivity to each other, wherein the configuring causes each OAMP to:
determine, via the OAMP fault detection protocol, when continuity has been lost to a first OAMP in the plurality of OAMPs; and
in response, raise a signal indicating loss of continuity to the first OAMP.

19. The method of claim 18 wherein the OAM fault detection protocol is Continuity Check (CC) protocol or Bidirectional Forwarding Detection (BPD) protocol.

20. The method of claim 18 wherein the plurality of OAMPs are designed to execute the OAM fault detection protocol in hardware, without intervention by a central processing unit (CPU) of the network device.
